(19) United States
(12) Patent Application Publication
(10) Pub. No.: US 2019/0035303 A1
(43) Pub. Date: Jan. 31, 2019

(54) Distributed Coaching

(71) Applicant: KONINKLIJKE PHILIPS N.V., EINDHOVEN (NL)

(72) Inventors: Annerieke HEUVELINK-MARCK, Eindhoven (NL); Arlette VAN WISSEN, Culemborg (NL); Cliff Johannes Robert Hubertina LASCHET, Gulpen (NL); Charlotte Dorothea Wilhelmina VINKERS, Eindhoven (NL)

(21) Appl. No.: 16/069,536

(22) PCT Filed: Jan. 20, 2017
(86) PCT No.: PCT/EP2017/051151

§ 371 Date: Jul. 12, 2018

Related U.S. Application Data
(60) Provisional application No. 62/280,927, filed on Jan. 20, 2016.
(60) Provisional application No. 62/384,973, filed on Sep. 8, 2016.

(51) Int. Cl. G09B 19/00

(52) U.S. Cl. CPC G09B 19/00

(57) ABSTRACT

Methods and systems for distributed coaching. A plurality of distributed intervention processes each calculate a priority for an intervention technique based on received user data. Then, a central arbiter process selects at least one intervention technique based on the associated priorities to be transmitted to a user to provide a tailored coaching experience for the user.

### TECHNICAL FIELD

Various embodiments described herein relate to automated coaching systems and methods and, more particularly, to methods and systems for performing distributed coaching.

### BACKGROUND

A behavior change support system (BCSS), also referred to more broadly as an ‘e-coaching system’ or ‘digital coaching system’, is a technology that supports its user in changing behaviors and cognitions related to health and wellness. There is an increasing availability of such systems, which can take the form of an application (“app”), website, smart device, etc. Current BCSSes, however, are constrained in their capability to successfully support behavior change, as they have limited ability to tailor their interventions (i.e., which, how, and when to offer them) based on the varying state and context of users in real-time and over time.

### SUMMARY

There are at least three reasons why current BCSSes typically have limited capabilities. First, intervention techniques (ITs) are often not declaratively specified, hindering the ability to separately control which IT is deployed to which user(s) and when.

Second, the ITs that are provided, and when they are provided, are often predefined and prescheduled by developers or behavior change experts. This makes it difficult to adapt different ITs to different user and context states once the intervention program has started. This requires system designers to design the system to ensure that the timing and the number of received ITs are in line with the preferences and context of the user. Although this is manageable for relatively small, focused BCSS, this becomes difficult when scaled across different domains, interventions, and developers.

Third, knowledge about the individual user (and their context) is typically updated infrequently at only one or a few moments in time. This makes it difficult to deploy dynamic and real-time coaching based on the changing needs of a user over time and in different contexts. For example, giving a user information about their behavior predictors can be effective when they are at home and feeling happy, but not when they are at work and feeling stressed. Accordingly, BCSSes run the risk of failing to establish a change in behavior and/or run the risk of eliciting a bad user experience.

In view of the foregoing, it would be beneficial to provide a coaching system and method that improve upon existing systems.

This summary is provided to introduce a selection of concepts in a simplified form that are further described below in the Detailed Description section. This summary is not intended to identify key features or essential features of the claimed subject matter, nor is it intended to be used as an aid in determining the scope of the claimed subject matter.

In one aspect, various embodiments relate to a distributed coaching system. The system includes a communications interface for at least receiving data about a user; a memory; and a processor, the memory storing instructions for configuring the processor to: execute multiple intervention processes, wherein each intervention process calculates a priority for an intervention technique based on the received user data; and execute an arbiter process that selects at least one intervention technique based on the priorities calculated by the multiple intervention processes, and transmits to the user at least one interaction element associated with the at least one selected intervention technique via the communication interface.

In one embodiment, the communications interface receives data from at least one sensor device providing data regarding at least one of psychological, physiological or contextual measurements from the user, and the priority calculation by at least one intervention process uses data from the at least one sensor device.

In one embodiment, the priority calculation by at least one intervention process uses data concerning at least one of the user's physiological state, psychological state, the user's external context, and previously executed intervention processes.

In one embodiment, the transmission of the at least one interaction element uses one or more of visual, auditory, and haptic-based methods, including an email message, a text message, an audio message, a haptic-based message, and an avatar-based message.

In one embodiment, the processor executes the multiple intervention processes in parallel.

In one embodiment, the arbiter process selects the at least one intervention technique based on the associated priority exceeding a threshold value.

In one embodiment, the arbiter process selects the at least one intervention technique at random from those intervention techniques having associated priorities exceeding threshold values.

In another aspect, various embodiments relate to a method for performing distributed coaching. The method includes receiving, via a communication interface, data about a user; executing, via a processor, multiple intervention processes, wherein each intervention process calculates a priority for an intervention technique based on the received user data; and executing, via the processor, an arbiter process that selects at least one intervention technique based on the priorities calculated by the multiple intervention processes, and transmits to the user at least one interaction element associated with the at least one selected intervention technique via the communication interface.

In one embodiment, the communications interface receives data from at least one sensor device providing data regarding at least one of psychological, physiological, or contextual measurements from the user, and the priority calculation by at least one intervention process uses data from the at least one sensor device.

In one embodiment, the priority calculation by at least one intervention process uses data concerning at least one of the user's physiological state, psychological state, the user's external context, and previously executed intervention processes.

In one embodiment, the transmission of the at least one interaction element uses one or more of visual, auditory, and haptic-based methods, including an email message, a text message, an audio message, a haptic-based message, and an avatar-based message.

In one embodiment, the processor executes the multiple intervention processes in parallel.

In one embodiment, the arbiter process selects the at least one intervention technique based on the associated priority exceeding a threshold value.

In one embodiment, the arbiter process selects the at least one intervention technique at random from those intervention techniques having associated priorities exceeding threshold values.

In yet another aspect, various embodiments relate to a computer readable medium containing computer-executable instructions for performing a method for distributed coaching. The medium includes computer-executable instructions for receiving, via a communication interface, data about a user; computer executable instructions for executing, via a processor, multiple intervention processes, wherein each intervention process calculates a priority for an intervention technique based on the received user data; and computer-executable instructions for executing, via the processor, an arbiter process that selects at least one intervention technique based on the priorities calculated by the multiple intervention processes, and transmits to the user at least one interaction element associated with the at least one selected intervention technique.

### BRIEF DESCRIPTION OF THE DRAWINGS

In order to better understand various example embodiments, reference is made to the accompanying drawings, wherein:

FIG. 1 illustrates a distributed coaching system in accordance with one embodiment;

FIG. 2 depicts exemplary external sensor devices of FIG. 1 in accordance with one embodiment;

FIG. 3 depicts exemplary user sensor devices of FIG. 1 in accordance with one embodiment;

FIG. 4 depicts a flowchart of a method for distributed coaching performed by the system of FIG. 1 in accordance with one embodiment;

FIG. 5 depicts a table listing exemplary features for a feedback intervention technique in accordance with one embodiment;

FIG. 6 depicts a table listing exemplary rules for the feedback intervention technique in accordance with one embodiment;

FIG. 7 depicts a flowchart of a method for distributed coaching in accordance with another embodiment; and

FIG. 8 illustrates an example of a hardware device for implementing the systems described herein in accordance with one embodiment.

### DETAILED DESCRIPTION

Various embodiments are described more fully below with reference to the accompanying drawings, which form a part hereof, and which show specific exemplary embodiments. However, the concepts of the present disclosure may be implemented in many different forms and should not be construed as limited to the embodiments set forth herein; rather, these embodiments are provided as part of a thorough and complete disclosure, to fully convey the scope of the concepts, techniques and implementations of the present disclosure to those skilled in the art. Embodiments may be practiced as methods, systems or devices. Accordingly, embodiments may take the form of a hardware implementation, an entirely software implementation or an implementation combining software and hardware aspects. The following detailed description is, therefore, not to be taken in a limiting sense.

Reference in the specification to “one embodiment” or to “an embodiment” means that a particular feature, structure, or characteristic described in connection with the embodiments is included in at least one example implementation or technique in accordance with the present disclosure. The appearances of the phrase “in one embodiment” in various places in the specification are not necessarily all referring to the same embodiment.

Some portions of the description that follow are presented in terms of symbolic representations of operations on non-transient signals stored within a computer memory. These descriptions and representations are used by those skilled in the data processing arts to most effectively convey the substance of their work to others skilled in the art. Such operations typically require physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices. Portions of the present disclosure include processes and instructions that may be embodied in software, firmware or hardware, and when embodied in software, may be downloaded to reside on and be operated from different platforms used by a variety of operating systems.

The present disclosure also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each may be coupled to a computer system bus. Furthermore, the computers referred to in the specification may include a single processor or may be architectures employing multiple processor designs for increased computing capability.

The processes and displays presented herein are not inherently related to any particular computer or other apparatus. Various general-purpose systems may also be used with programs in accordance with the teachings herein, or it may prove convenient to construct more specialized apparatus to perform one or more method steps. The structure for a variety of these systems is discussed in the description below. In addition, any particular programming language that is sufficient for achieving the techniques and implementations of the present disclosure may be used. A variety of programming languages may be used to implement the present disclosure as discussed herein.

In addition, the language used in the specification has been principally selected for readability and instructional purposes and may not have been selected to delineate or circumscribe the disclosed subject matter. Accordingly, the present disclosure is intended to be illustrative, and not limiting, of the scope of the concepts discussed herein.

Various embodiments described herein provide an implementation of a new approach to design digital coaching systems such that they are (i) adaptive to the user state and context, and (ii) scalable over different users and contexts, as well as over the number and types of interventions they can offer. As a result, such a system will provide users with a stable and tailored experience.

Various embodiments described herein couple sensory information to action selection by decomposing the complete behavior into sub-behaviors, implemented as a hierarchy of layers. The layers, which receive sensor information, work in parallel and generate outputs. As used herein, the term “parallel” will be understood to encompass not only processes that are processed as parallel threads, but also processes that are executed at different times but are nonetheless independent from the other processes. This architecture emphasizes the strength of distributive and parallel control to come to action selection. The presented approach proposes using similar distributed processes followed by a central arbiter process to determine which IT should be used and sent to the user. As a first reasoning step, distributed reasoning elements process updates in user states in order to determine the priority of the ITs based on their applicability and relevance. In the second reasoning step a central arbiter process determines which from these applicable and relevant ITs should be used and sent to the user.

In the context of the present disclosure, the term “coaching system” may refer to a system that supports users in changing behaviors and cognitions such as those related to health and wellness, whether physical or mental.

In the context of the present disclosure, the term “intervention” may refer to a complete solution or (sub) program offered by the coaching system to a user.

In the context of the present disclosure, the term “intervention process” may refer to the internal processes that in parallel reason about the priority and instantiation of the ITs.

In the context of the present disclosure, the term “intervention technique” (IT) may refer to an active component of the intervention that is designed to support the user in reaching a behavior change goal. Intervention processes may specify one or more ITs to be used in achieving or working toward the goals of the intervention.

In the context of the present intervention, the term “interaction element” (IE) may refer to an observable interaction of the coaching system with the user (e.g., a message to the user). Interaction elements may be the result of an instantiation of an intervention technique.

Existing coaching systems declaratively specify the active components of the interventions (i.e. the ITs). However, the scheduling of ITs (which intervention technique should be activated and when) in existing coaching systems is typically predefined. Consequently, multiple ITs may be activated at once and therefore interaction elements may be sent to the user at the same time. It is the responsibility of the designer of the system to anticipate the coordination of ITs to ensure that the timing and number of received interaction elements (IEs) are in line with the preferences and context of the user.

However, the designer also needs to ensure that not too many workflows can become active at the same time (based on, e.g., changes in measured behavior or user context) which could result in too many interactions with the user and a bad user experience. This is particularly likely when a user subscribes to multiple interventions that were designed in isolation (e.g., by different designers or for different intervention domains). As such, it is hard for designers to anticipate all possible intervention technique activations and how they together might influence each other or impact the user experience.

Various embodiments described herein provide solutions to this problem by splitting the process of determining which IT(s) are selected and which IEs are sent in two steps; (1) distributed processing; and (2) central arbiter selection. This combination of distributed processing and central arbiter selection to determine which interaction elements are sent is embodied in, e.g., an automated coaching system. This approach may be more scalable than those in which conditions and triggers are defined for each IT in isolation by a human designer, because the proposed system described herein automatically handles interactions, effects and competition between the ITs. Accordingly, this results in an improved user experience and improved interventions that are better tailored to the current user's state and/or context.

FIG. 1 depicts a system 100 for distributed coaching in accordance with one embodiment. The system 100 may provide distributed coaching for a user 102. In particular, the system 100 may automatically select the most appropriate intervention technique (and interaction element) based on a plurality of factors such as the user's context and user state as determined by the external sensor device(s) 104 and user sensor device(s) 106.

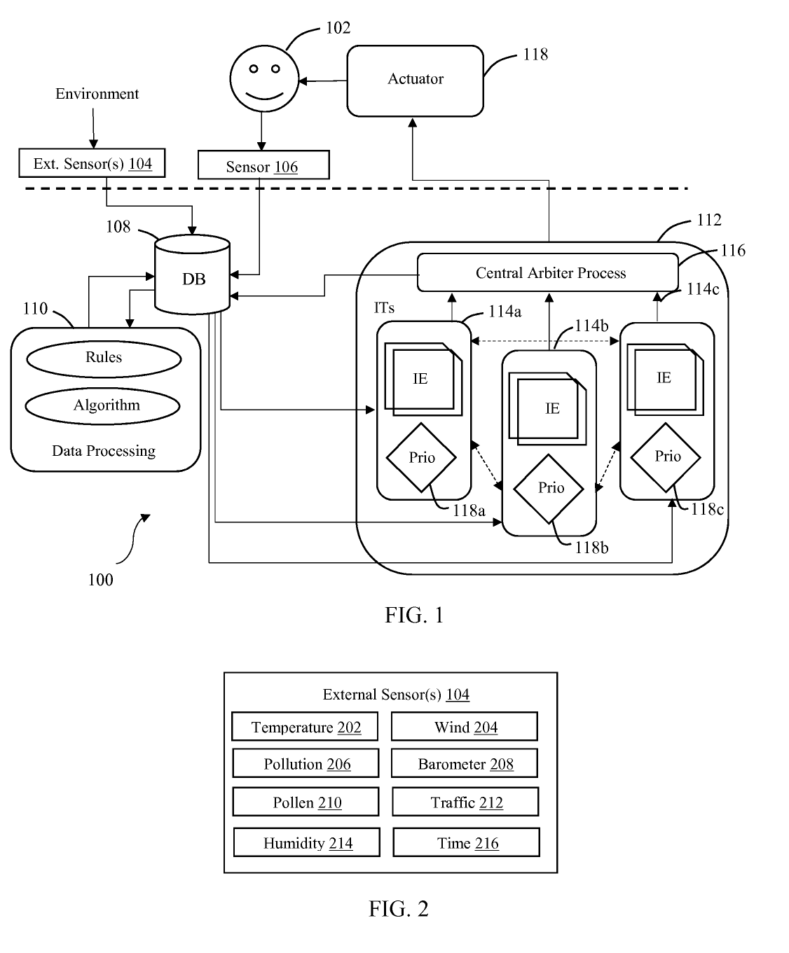

Exemplary external sensor devices 104 are illustrated in FIG. 2 and may gather information related to the user's external environment. These may include sensor devices for gathering information related to temperature 202, wind speed 204, pollution 206, air pressure 208, pollen 210 (e.g., if a user has allergies and there is a high pollen content in their neighborhood, they may be less able to go outside and exercise), traffic in an environment 212 (a user may be less inclined to exercise on street or pedestrian path with high traffic), humidity 214, time of day 216, or any other type of information that may relevant in determining whether a user is susceptible to and/or able to respond to an instantiated IT (i.e., an interaction element).

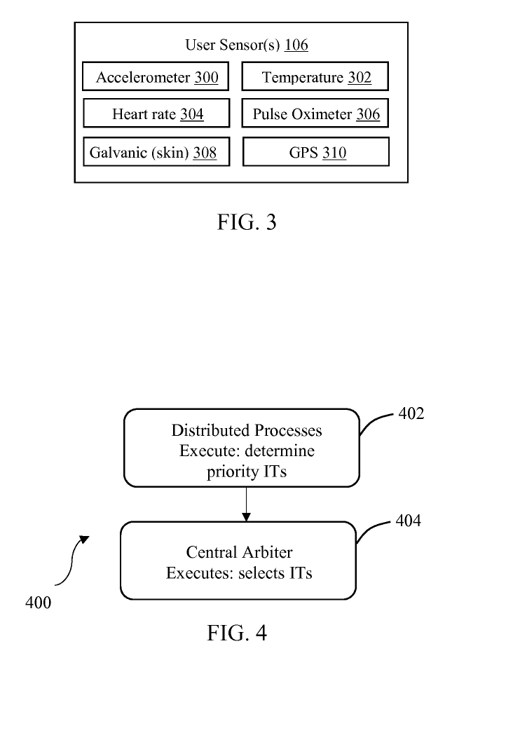

Exemplary user sensor devices 106 are illustrated in FIG. 3 and may gather information related to the behavior of the user 102. These may include accelerometers 300, temperature sensors 302, heart rate sensor(s) 304, pulse oximeter(s) 306, galvanic skin sensor(s) 308 (e.g., to measure sweat), and global positioning system (GPS) sensors 310, or any other type of sensor device to gather information regarding the behavior and internal state of the user 102.

Various features may also use surveys to gather information regarding a user. For example, a user interface (not shown in FIG. 1) may present questions (periodically or aperiodically) to a user regarding their state. These surveys or questionnaires may present questions in a Likert-based format, for example, in which the user's answer(s) may be based off of a ranking or scale. A sample question may be “how tired are you?” and the user may select a number in the range of 1-5; “1” indicating the user is not tired, and “5” indicating the user is extremely tired.

Referring back to FIG. 1, data gathered by the external sensor device(s) 104 and the user sensor device(s) 106 may be communicated to the database 108. This information may be communicated via any suitable wireless or hardwired connection.

The database 108 may store data regarding the user's context and state (based on information gathered by the external sensor device(s) 104 and the user sensor device(s) 106). The database 108 may further be in communication with a data processing module 110 that may derive and/or learn new data from stored data. For example, for a given data set, the processing module 110 may calculate various derivatives of the data, including but not limited to simple averages (i.e., a mean(s), weighted averages, standard deviations, etc.). In some embodiments, the data processing module 110 may be implemented as a single pole filter, a multiple filter, a Kalman filter, etc.

The database 108 may be in further communication with the processor 112. The processor 112 may perform the method 400 of FIG. 4, which involves a distributed processing step 402 to determine the priorities of ITs and a central arbiter selection step 404 to select one or more ITs. According to some embodiments, the two-step method 400 is used to generate coaching content in an application to support users (such as patients) with physical activity. An aim of this implementation is to use this method 400 to show how behavior change intervention techniques can be dynamically offered, such that users receive content that is not just personalized but also tailored to their current state.

The method 400 of FIG. 4 may be performed by multiple distributed intervention processes 114a-c and a central arbiter process 116. The distributed intervention processes 114a-c may be triggered by any combination of the data obtained from the external sensor device(s) 104 and the user sensor device(s) 106. Each process 114a-c corresponds to one IT and, in parallel, each determine a priority 118a-c for their IT's execution. The priorities 118a-c may be based on several features (i.e. characteristics) of the user input stored in the database 108. How these distributed processes are implemented is domain specific and can vary for each application and user. Although only three processes 114a-c are shown, other embodiments may execute more or less processes.

In a simple example, the execution of these processes 114a-c may result in a Boolean value (yes: priority to be executed, no: no priority to be executed). Additionally or alternatively, the priorities 118a-c may be numerical values calculated using a function based on features such as the user's preferences, psychological traits, physiological state, external context, and the history of sent ITs.

The priorities 118a-c of the processes 114a-c, respectively, may also depend on each other. In that case, activation of one IT may inhibit the activation of another IT(s), such that there is only one IT with the highest priority.

The priorities 118a-c for each process 114a-c may then be communicated to the central arbiter process 116. The central arbiter process 116 may receive the priority values 118a-c from the distributed reasoning processes 114a-c and return an IT (or a list of ITs) and corresponding actions to be executed by the actuator 118. The actuator 118 may be any number of any type of device that delivers the interaction element to the user. For example, the actuator 118 may be configured as a smartphone or other type of mobile device able to transmit one or more interaction elements as a visual signal, an audio signal, a haptic-based signal, or some combination thereof. The actuator may similarly be implemented as a user's tablet, laptop, PC, television, or as a device worn by the user.

The way in which the distributed coaching process is implemented can differ for different domains and applications, and can vary in complexity level as well. For example, the central arbiter process 116 could simply select the IT with the highest priority (e.g., that surpasses a certain fixed threshold), and select a random IT from a set of multiple ITs surpassing a certain threshold. This threshold can vary and can be based on the number of applicable ITs (e.g., the threshold is high in case there are many applicable ITs).

In a more complex alternative, the threshold can be a dynamic value based on (for instance) limitations on the number of intervention techniques that can be scheduled, or on the history of the number of executed intervention techniques for a particular user. A more complex variant is where the threshold differs over time based on, e.g., limitations on the number of ITs to be sent in a given time period, or whether or not multiple ITs can be selected and interaction elements delivered to the user in an integrated way.

As mentioned previously, various features may be used to assist users in increasing their physical activity and reaching their fitness goals. In this embodiment, the types of data in the system 100 may include the following data entries and (and exemplary values): (1) User Goal: walk 45 minutes every day; (2) Motivation: low; (3) Ego-depletion: low; and (4) User Preferred Frequency Interactions: many. It will be apparent that other embodiments may use data types in addition to or in lieu of those mentioned here.

For this embodiment, the particular interaction elements may include email, text on a mobile device, avatar on a mobile device, an SMS message, a haptic-based alert on a mobile device, a visual alert on a mobile device, or the like. It will be apparent that other embodiments may use interaction elements in addition to or in lieu of those mentioned here.

Also in this type of embodiment, the implemented ITs may include: (1) feedback on behavior; (2) discrepancy between behavior and the user's goal(s); and (3) commitment. It will be apparent that other embodiments may use different types of ITs in addition to or in lieu of those mentioned here. For each of the techniques, there is a reasoning process that determines the technique's priority to be executed based on the incoming data about the current user state (such as activity and location) and other data in the system. According to some embodiments, the priority depends on four different features of the ITs.

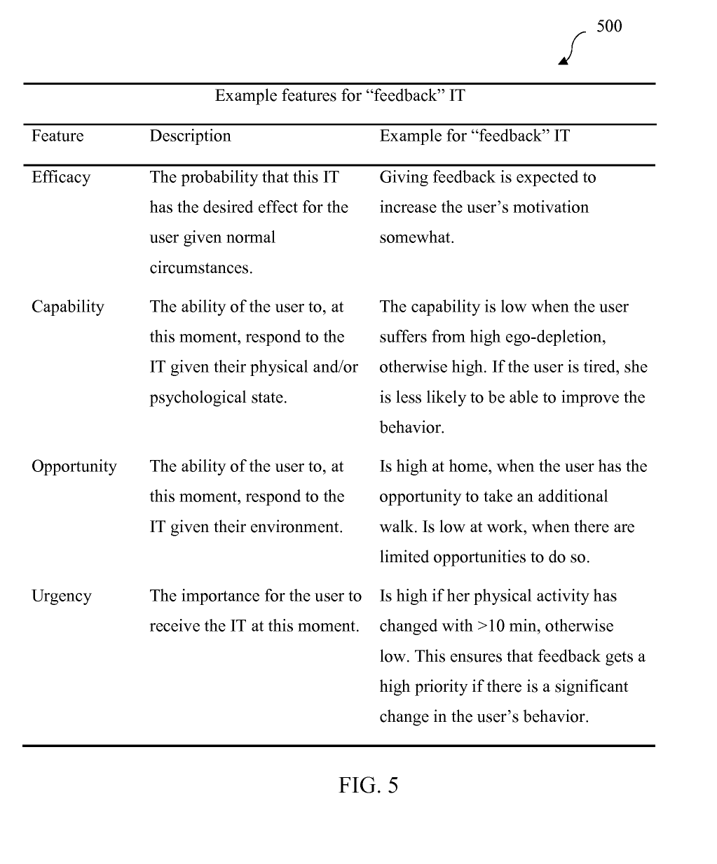

For example, FIG. 5 depicts a table 500 that displays four features (characteristics) related to a user who has set one or more fitness goals. For example, an exemplary fitness goal set by the user may be to walk 45 minutes each day. Various features may therefore monitor and provide informative or evaluative feedback on the user's performance (e.g., how much she walks each day).

The four features of table 500 are: (1) Efficacy—the probability that an IT has the desired effect for the user under normal circumstances; (2) Capability—the ability of the user to, at this moment, respond to an IT given their physical and/or psychological state; (3) Opportunity—the ability of the user to, at this moment, respond to an IT given their environment; and (4) Urgency—the importance of the user to receive the IT at this moment. Table 500 also lists examples of possible “feedback” ITs.

The efficacy may be estimated from literature or learned by observing and measuring the effects of the IT. The way the urgency is calculated may vary greatly between ITs. For example, the urgency for “goal discrepancy” may depend on the amount of time that the user is over- or underperforming, while the urgency for “commitment” (where the user is asked questions to commit to their daily goal) may decay during the day.

Efficacy and urgency may contribute directly to the priority, while capability and opportunity are moderators that influence the efficacy. How the features are combined to calculate the final priority may also differ per IT, and may result in a value between 0-1, for example.

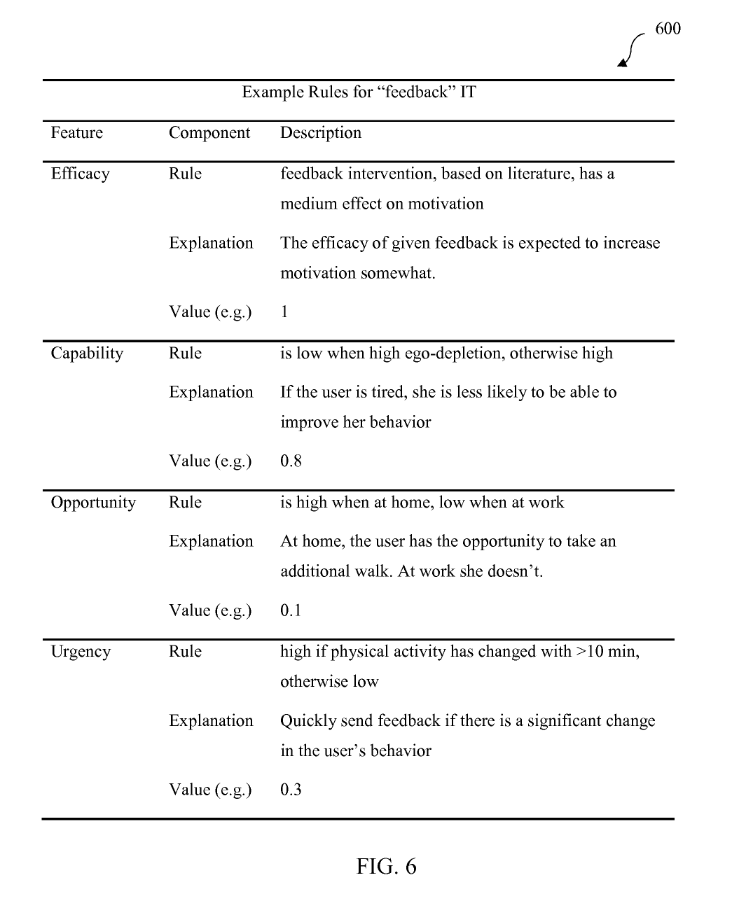

FIG. 6 depicts a table 600 showing exemplary rules, explanations, and values for each feature of the “feedback” IT. The example calculations below state the rules (as well as their explanations) that may be found in the system 100 for each feature.

According to some embodiments, the priority is determined by a weighted sum of the features, whose weights vary between ITs. This reflects the notion that some features can moderate others. That is, the user's capability and opportunity at a given moment may act as a moderator for the efficacy given normal circumstances and for the urgency to deliver an IT at this moment in time.

How these features are combined to calculate the final priority may differ for each IT. In various embodiments, priorities are a value between 0-1. For example:

$$\begin{matrix}feedback priority = \frac{( capability * opportunity * efficacy ) + urgency}{2} = ( e . g . ) 0.19 & ( Eq . 1 ) \\ goal discrepancy priority = \frac{( urgency + efficacy )}{2} = ( e . g . ) 0.65 & ( Eq . 2 ) \\ commitment priority = \frac{efficacy * ( capability + opportunity ) + urgency}{3} = ( e . g . ) 0.40 & ( Eq . 3 )\end{matrix}$$

Alternatively, in some embodiments, these may also reflect that the ITs can influence each other. For example, if there are strategies that are expected to influence the same behavioral determinant, those strategies can inhibit each other. For example, the priorities of feedback and goal discrepancy could be interdependent: if for one of them the priority values increases, the priority value of the other one will decrease.

Assume the user has indicated that her preferred frequency of interactions is “high” as she does not mind receiving multiple instantiated intervention techniques (i.e., multiple interaction elements). Therefore, the threshold for priorities to get selected is set to low, e.g. 0.3, such that all ITs with a priority equal to or above 0.3 will be executed and delivered to the user. In this case, the central arbiter process 116 compares the priorities among the ITs and selects at least one of those that have a priority above the threshold (goal discrepancy and commitment). The user may therefore receive both of these ITs, but not any ITs related to feedback because the feedback priority (0.19) is below the threshold of 0.3. Alternatively, in some embodiments, the central arbiter process 116 need not use a threshold function, but may pick the IT (or group of n ITs, where n is a number of ITs to send at any given time) with the highest priority.

Consider the scenario in which the user's goal is to walk 45 minutes every day, but her motivation at a particular point in the day to do so is low. The system sensors 104 and 106 may detect that the user has walked 15 minutes (using, e.g., an accelerometer) and that she is at home (using, e.g., GPS or iBeacons).

The processor 112 may use this data and determine what is the most appropriate intervention technique (if any) to support the user. The distributed processes 114a-c may calculate the feature values and combine them into one priority value. In our scenario, the priority values per IT could be 0.73 for feedback, 0.58 for goal discrepancy, and 0.32 for commitment. Other ITs may not become active at all because, for instance, they are not applicable or there is not enough data.

One or more interaction elements may be transmitted to the user depending on the user's preferences. For example, an interaction element associated with the feedback IT may be transmitted to the user to inform her of the number of steps she has taken within a predetermined time, and an interaction element associated with the goal discrepancy IT may be transmitted to inform her of her progress with respect to her goal. The interaction elements may be transmitted to the user via any of the methods described above.

Accordingly, various embodiments provide a new approach to design behavior change support systems such that they are (i) adaptive to the user state and/or context, and (ii) scalable over different users and contexts as well as over the number and types ITs they can offer.

This approach enables tailored coaching from the very start of the user's use of the system 100. The system 100 may also include the capability to learn the specific nuances of what works best for a particular user. For example, the weights of the features and the threshold of the priorities can be learned from the user interactions and observing the user's behavior.

Various approaches to machine learning such as regression, neural networks, Bayesian networks, etc., may be applied to accomplish such learning. Also, these values could be estimated from analyzing data of user groups. As a result, the system 100 has the potential to provide better tailored content to the user as well as an improved user experience.

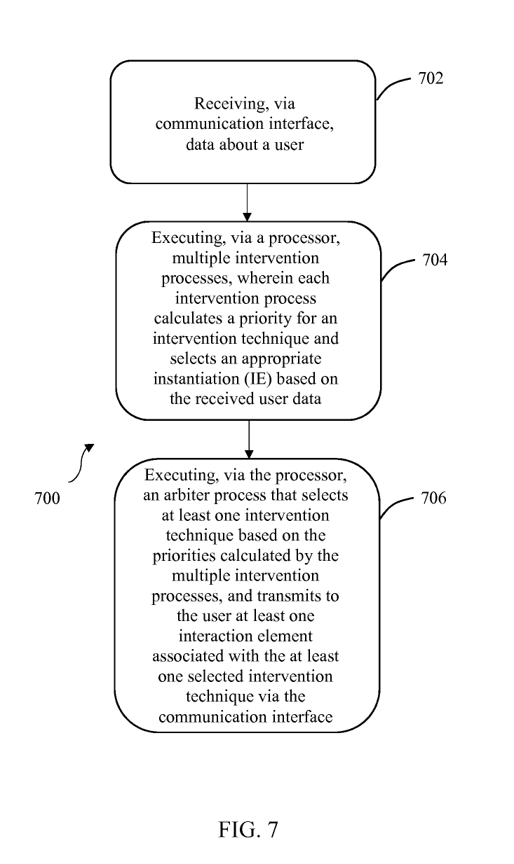

FIG. 7 depicts a flowchart of a method 700 for performing distributed coaching in accordance with one embodiment. Step 702 of method 700 involves receiving, via a communication interface, data about a user. This data may be obtained in real time from sensors such as those described in conjunction with the external sensor device(s) 104 and the user sensor device(s) 106. As mentioned previously, this data may be related to the user's context and state.

Step 704 involves executing, via a processor, multiple intervention processes, wherein each intervention process calculates a priority for an intervention technique and selects an appropriate instantiation (IE) based on the received user data. These intervention processes may be executed in accordance with the methods described above.

Step 706 involves executing, via the processor, an arbiter process that selects at least one intervention technique based on the priorities calculated by the multiple intervention processes, and transmits to the user at least one interaction element associated with the at least one selected intervention technique via the communication interface. The arbiter process may select one or more intervention techniques based on those with priorities exceeding a threshold, for example.

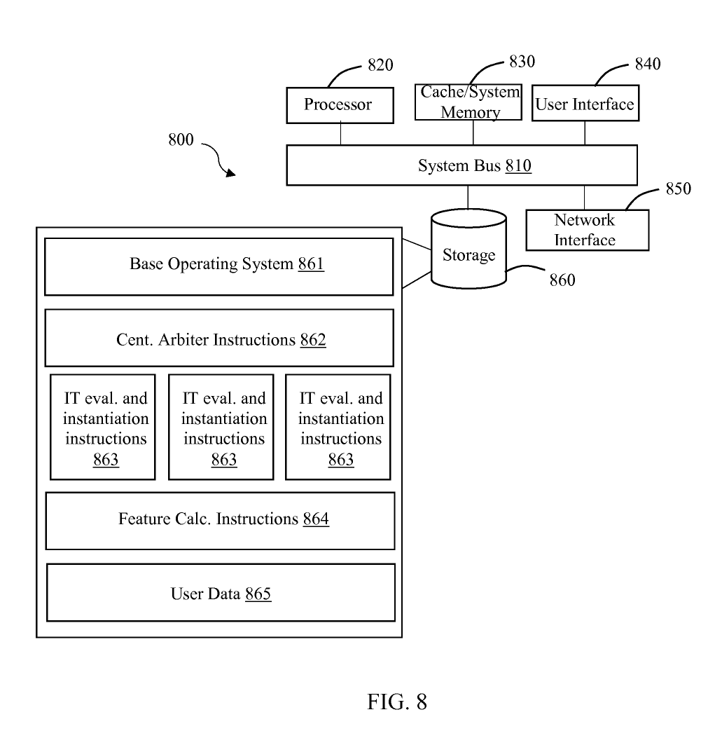

FIG. 8 illustrates an exemplary hardware diagram 800 for implementing a coaching system as described herein. The exemplary hardware 800 may correspond to one or more of the devices of FIG. 1 such as, for example, the processor 112. As shown, the device 800 includes a processor 820, memory 830, user interface 840, network interface 850, and storage 860 interconnected via one or more system buses 810. It will be understood that FIG. 8 constitutes, in some respects, an abstraction and that the actual organization of the components of the device 800 may be more complex than illustrated.

The processor 820 may be any hardware device capable of executing instructions stored in memory 830 or storage 860 or otherwise processing data. As such, the processor may include a microprocessor, field programmable gate array (FPGA), application-specific integrated circuit (ASIC), or other similar devices.

The memory 830 may include various memories such as, for example L1, L2, or L3 cache or system memory. As such, the memory 830 may include static random access memory (SRAM), dynamic RAM (DRAM), flash memory, read only memory (ROM), or other similar memory devices.

The user interface 840 may include one or more devices for enabling communication with a user. For example, the user interface 840 may include a display, a mouse, and a keyboard for receiving user commands. In some embodiments, the user interface 840 may include a command line interface or graphical user interface that may be presented to a remote terminal via the network interface 850.

The network interface 850 may include one or more devices for enabling communication with other hardware devices. For example, the network interface 850 may include a network interface card (NIC) configured to communicate according to the Ethernet protocol. Additionally, the network interface 850 may implement a TCP/IP stack for communication according to the TCP/IP protocols. Various alternative or additional hardware or configurations for the network interface 850 will be apparent.

The storage 860 may include one or more machine-readable storage media such as read-only memory (ROM), random-access memory (RAM), magnetic disk storage media, optical storage media, flash-memory devices, or similar storage media. In various embodiments, the storage 860 may store instructions for execution by the processor 820 or data upon with the processor 820 may operate. For example, the storage 860 may store a base operating system 861 for controlling various basic operations of the hardware 800. The storage also includes central arbiter instructions 862 for defining a process for selecting one or more ITs based on their respective priorities; multiple sets of IT priority evaluation and instantiation instructions 863, each for computing a priority for a particular IT and an appropriate instantiation based on current features of the user; feature calculation instructions 864 for calculating features for the user such as efficacy, urgency, opportunity, and capability; and user data 865 for storing information about the user such as demographic information, physiological parameters, location, and other information about the user or their environment on which feature calculation may be based.

It will be apparent that various information described as stored in the storage 860 may be additionally or alternatively stored in the memory 830. In this respect, the memory 830 may also be considered to constitute a “storage device” and the storage 860 may be considered a “memory.” Various other arrangements will be apparent. Further, the memory 830 and storage 860 may both be considered to be “non-transitory machine-readable media.” As used herein, the term “non-transitory” will be understood to exclude transitory signals but to include all forms of storage, including both volatile and non-volatile memories.

While the device 800 is shown as including one of each described component, the various components may be duplicated in various embodiments. For example, the processor 820 may include multiple microprocessors that are configured to independently execute the methods described herein or are configured to perform steps or subroutines of the methods described herein such that the multiple processors cooperate to achieve the functionality described herein. Further, where the device 800 is implemented in a cloud computing system, the various hardware components may belong to separate physical systems. For example, the processor 820 may include a first processor in a first server and a second processor in a second server. Such distributed processors may, for example, execute different ones of the IT priority evaluation instructions 863 for delivery of an interaction element to yet another processor executing the central arbiter instructions 862.

The proposed approach is more scalable than existing approaches in which conditions and triggers are defined for each IT in isolation by the designer, because the system 100 of the proposed approach automatically handles interactions effects and competition between the ITs. Various embodiments are particularly well suited for digital coaching systems that interact and motivate the user for a longer period of time, given its potential to seamlessly adapt the content and delivery of this content to the constantly changing state and context of the user.

Although the features have been described in conjunction with helping users increase their physical activity, the features described herein may be used in other applications as well. For example, the features may assist users in adhering to medication, smoking cessation, decreasing salt intake, or the like. Accordingly, features described herein are applicable to multiple businesses, such as Hospital to Home, Personal Health Solutions, Mother & Child Care, Sleep and Respiratory Care, or the like. More broadly, features described herein may be applied in any application to ensure system-user interactions are tailored to the user and their context.

It should be apparent from the foregoing description that various example embodiments may be implemented in hardware or firmware. Furthermore, various exemplary embodiments may be implemented as instructions stored on a machine-readable storage medium, which may be read and executed by at least one processor to perform the operations described in detail herein. A machine-readable storage medium may include any mechanism for storing information in a form readable by a machine, such as a personal or laptop computer, a server, or other computing device. Thus, a machine-readable storage medium may include read-only memory (ROM), random-access memory (RAM), magnetic disk storage media, optical storage media, flash-memory devices, and similar storage media.

It should be appreciated by those skilled in the art that any block diagrams herein represent conceptual views of illustrative circuitry embodying the principles described herein. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications can be affected while remaining within the spirit and scope of the invention. Accordingly, the foregoing disclosure, description, and figures are for illustrative purposes only and do not in any way limit the invention, which is defined only by the claims.

1. A distributed coaching system, the system comprising:
a communications interface for at least receiving data about a user;
a memory; and
a processor, the memory storing instructions for configuring the processor to:
execute multiple intervention processes, wherein each intervention process calculates a priority for an intervention technique based on the received user data; and
execute an arbiter process that selects at least one intervention technique based on the priorities calculated by the multiple intervention processes, and transmits to the user at least one interaction element associated with the at least one selected intervention technique via the communication interface, wherein the communications interface receives data from at least one sensor device providing data regarding at least one of psychological, physiological, or contextual measurements from the user, and the priority calculation by at least one intervention process uses data from the at least one sensor device.

2. (canceled)

3. The system of claim 1, wherein the priority calculation by at least one intervention process uses data concerning at least one of the user's physiological state, psychological state, the user's external context, and previously executed intervention processes.

4. The system of claim 1, wherein the transmission of the at least one interaction element uses one or more of visual, auditory, and haptic-based methods, including an email message, a text message, an audio message, a haptic-based message, and an avatar-based message.

5. The system of claim 1, wherein the processor executes the multiple intervention processes in parallel.

6. The system of claim 1, wherein the arbiter process selects the at least one intervention technique based on the associated priority exceeding a threshold value.

7. The system of claim 1, wherein the arbiter process selects the at least one intervention technique at random from those intervention techniques having associated priorities exceeding threshold values.

8. A method for performing distributed coaching, the method comprising:
receiving, via a communication interface, data about a user;
executing, via a processor, multiple intervention processes, wherein each intervention process calculates a priority for an intervention technique based on the received user data; and
executing, via the processor, an arbiter process that selects at least one intervention technique based on the priorities calculated by the multiple intervention processes, and transmits to the user at least one interaction element associated with the at least one selected intervention technique via the communication interface-, wherein the communications interface receives data from at least one sensor device providing data regarding at least one of psychological, physiological, or contextual measurements from the user, and the priority calculation by at least one intervention process uses data from the at least one sensor device.

9. (canceled)

10. The method of claim 8, wherein the priority calculation by at least one intervention process uses data concerning at least one of the user's physiological state, psychological state, the user's external context, and previously executed intervention processes.

11. The method of claim 8, wherein the transmission of the at least one interaction element uses one or more of visual, auditory, and haptic-based methods, including an email message, a text message, an audio message, a haptic-based message, and an avatar-based message.

12. The method of claim 8, wherein the processor executes the multiple intervention processes in parallel.

13. The method of claim 8, wherein the arbiter process selects the at least one intervention technique based on the associated priority exceeding a threshold value.

14. The method of claim 8, wherein the arbiter process selects the at least one intervention technique at random from those intervention techniques having associated priorities exceeding threshold values.

15. A computer readable medium containing computer-executable instructions for performing a method for distributed coaching, the medium comprising:
computer-executable instructions for receiving, via a communication interface, data about a user;
computer-executable instructions for executing, via a processor, multiple intervention processes, wherein each intervention process calculates a priority for an intervention technique based on the received user data; and
computer-executable instructions for executing, via the processor, an arbiter process that selects at least one intervention technique based on the priorities calculated by the multiple intervention processes, and transmits to the user at least one interaction element associated with the at least one selected intervention technique,
wherein the communications interface receives data from at least one sensor device providing data regarding at least one of psychological, physiological, or contextual measurements from the user, and the priority calculation by at least one intervention process uses data from the at least one sensor device.
